(19) United States
(12) Patent Application Publication
(10) Pub. No.: US 2008/0146194 A1
(43) Pub. Date: Jun. 19, 2008

(54) Automatic data back up and account creation

(75) Inventors: Lie Yang, Palo Alto, CA (US); Zvi Ashkenazi, Cupertino, CA (US)

Correspondence Address: YAHOO C/O MOFO PALO ALTO, 755 PAGE MILL ROAD, PALO ALTO, CA, 94304, US

(73) Assignee: Yahoo! Inc., Sunnyvale, CA (US)

(21) Appl. No.: 11/639,852

(22) Filed: Dec. 15, 2006

(51) Int. Cl. H04M 1/66

(52) U.S. Cl. 455/411

(57) ABSTRACT

An apparatus is provided for automatically backing up user data from a client device and creating a user account. The apparatus includes interface logic for receiving user data from a client device, identification logic for receiving identification information associated with the device, and account logic for causing the creation of an account with a service provider, wherein account credentials for the account are based on the identification information associated with the device. In some examples, the account is created without user generated credentials (e.g., without a user entered name and password). The identification information associated with the device (or device identifier) may include a MAC address, IMEI, MSISDNI, or other suitable identifier associated with the device. The user data may include data associated with a PIM application such as contacts, calendar, notes, and the like, data associated with SMS or MMS, or with a media object.

### BACKGROUND

The present invention relates generally to the back up of user data, and in one example, to the back up of user data for a mobile computing device such as a mobile phone, personal assistant, or the like.

A variety of mobile computing devices exist, such as personal digital assistants (PDAs), mobile phones, smart phones, camera phones, pocket personal computers, and the like which perform an ever growing variety of functions. The trend is for mobile computing devices to have increased functionality such that a single mobile device may, for example, provide Internet access, maintain personal contacts and a personal calendar, provide mobile telephony, take digital photographs, play music files, and the like.

Personal data, such as Personal Information Management (PIM) data, can be backed-up and synchronized with network applications, desktop computer applications, or other databases within a telecommunications system. For example, PIM data such as contact information and calendar entries may be backed-up and/or synchronized between multiple devices via a communication system.

The SyncML (Synchronization Markup Language), which is based on the XML (extensible Markup Language), is well known for the synchronization of data between two or more devices, e.g., a client device and a server device. The SyncML synchronization protocol using messages in the SyncML format (SyncML messages) generally allows for synchronization of data in any application between any networked terminals. For example, a contact entry of a user device is synchronized with a network contact program or a calendar entry in a user device is synchronized with a network calendar.

FIG. 1 illustrates an exemplary system where a client device, e.g., a cell phone or other mobile device, functions as a SyncML client terminal and a data source, e.g., a computer or network server computer, functions as the SyncML server. SyncML client terminal synchronization application layer functions are provided by a synchronization client agent, which implements the SyncML protocol by sending a SyncML package (e.g., Client Modifications), which includes, in one or more SyncML messages, modifications made after the last synchronization session to the data that is the object of synchronization in the mobile device. SyncML/data source server synchronization application layer functions are provided by a sync server agent, which controls synchronization. The server usually waits for an initiative for synchronization from the SyncML client. The server synchronizes the data by analyzing the changes made to the database and client terminal data, and synchronizes the data (i.e., makes necessary modifications, replacements, and deletions). After synchronizing the data, the SyncML server sends the server modifications back to the SyncML client. The SyncML protocol and environment is described in greater detail, for example, in “SyncML Sync Protocol, version 1.1.” dated Oct. 2, 2002, (which is put forth by the Open Mobile Alliance (“OMA”) and provided at “http://www.openmobilealliance.org”, and for which the entire content is incorporated by reference herein).

Accordingly, a user of a device may use a SyncML server to back up and synchronize data with an existing account of a service provider (e.g., a Yahoo!® Mail account or the like). If a user does not have an existing account with a particular service provider and wishes to back up data from a user device the user may create an account via the device. Creating a new account with a service provider typically requires the user to complete various registration processes, for example, at least entering a name and password (e.g., credentials for use with the service provider network). The process of creating and registering a new account may create a barrier for some users to back up their user data, thereby failing to take advantage of available data back up and service provider features.

### SUMMARY

According to one aspect provided herein, an apparatus is provided for backing up user data from a client device and automatically creating a user account. In one example, the apparatus includes interface logic for receiving user data from a client device, identification logic for receiving identification information associated with the device, and account logic for causing the creation of an account with a service provider, wherein account credentials for the account are based on the identification information associated with the device.

In some examples, the account is created without user entered account credentials (e.g., without a user entered name and password). The identification information associated with the device (or device identifier) may include one or more of a Media Access Control (MAC) address, International Mobile Equipment Identity (IMEI), Mobile Station Integrated Services Digital Network Identity (MSISDNI), or other suitable identifier associated with the device.

In some examples, the apparatus may further include logic operable to initiate a request to the device for the user to enter a username and password for the account. The request may include a link, e.g., a smart link, to the device for updating the account, and further may include various reminders or warnings to update their account. Additionally, the user may be provided with a key for accessing the newly created account and associating their identity therewith.

In some examples, the user data may include data associated with a Personal Information Management (PIM) application such as contacts, calendar, notes, and the like. The user data may further include data associated with a Short Messaging Service or a Multimedia Messaging Service. The user data may further include data associated with a media object (e.g., still image, moving images, audio, etc.) or a media object application.

According to another aspect and example, a method for backing up user data from a client device is provided. In one example, the method includes receiving user data from a device, receiving identification information associated with the device, and creating an account with a service provider for storing the user data, wherein the account credentials comprise the identification information of the device.

According to another aspect and example, a computer program product comprising program instructions for causing the back up of user data is provided. In one example, the computer program instructions include program code operable to cause the creation of a user account with a service provider for backing up user data from a remote device, the account created based on identification information associated with the remote device. The program instructions may further include program code for receiving the identification information associated with the remote device and program code for receiving the user data.

The present invention and its various aspects are better understood upon consideration of the detailed description below in conjunction with the accompanying drawings and claims.

### BRIEF DESCRIPTION OF THE DRAWINGS

FIG. 1 illustrates a prior art system and method for synchronizing a client device and a server device;

FIG. 2 illustrates a basic architecture in which various aspects described herein may operate;

FIGS. 3A and 3B illustrate exemplary user interfaces of a client device operable to prompt a user to back up data and access the data (which may further be synchronized);

FIG. 4 illustrates an exemplary signaling chart between a client device and a server device associated with or in communication with a service provider network;

FIGS. 5A and 5B illustrate exemplary methods for backing up data and creating new accounts; and

FIG. 6 illustrates an exemplary computing system that may be employed to implement processing functionality for various aspects of the present invention.

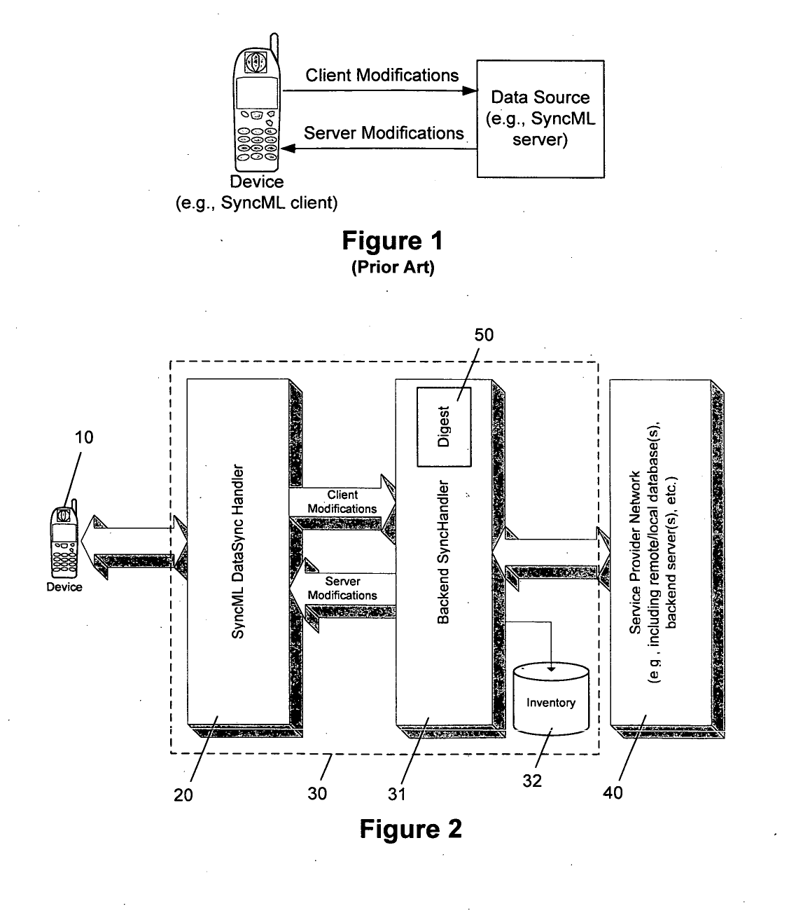

### DETAILED DESCRIPTION

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

Conventionally, a mobile device user desiring to back up user data with a service provider account, e.g., associated with a personal email account such as a Yahoo!® account or Hotmail® account, is required to first create an account with the service provider, wherein creating the account typically requires the user to register with the service provider. For example, at the very least, a user generally enters conventional credentials, e.g., a username and password. This process can be burdensome and time consuming for some users, particularly when setting-up a new device; accordingly, in one example provided herein, an account is created and associated with a mobile device automatically, without requiring the entry of conventional credentials by the user, thereby streamlining the provisioning of the device.

Accordingly, one aspect of the present invention includes a method and system for backing up data and creating a user account via a client device, e.g., a mobile device such as a mobile phone. Broadly speaking, during a provisioning process of a device, the system (e.g., including a server) receives or determines a unique identifier of the device (e.g., a MAC address, IMEI, MSISDN, or the like) and automatically generates or creates an account with a service provider for backing up user data from the device, the account created based on the unique identification of the device. In one example, credentials used for the created account include, or are at least based upon, the unique identifier of the device. The system and process may provide a relatively quick provisioning flow (and a compelling reason for a user to create an account with a service provider).

The device may receive a key in the form of new data for accessing the backed up data and created account. Additionally, a user may enter conventional credentials (if desired) at a later time and access the account via the user device or from another device having access to the account created with the service provider.

The present invention may therefore be used in various applications were data may be desired to be backed up from a connected device. For example, the data may relate to various applications, such as Contacts, Calendar, Photos, videos or any other user generated content such as SMS, MMS, Media Objects, and the like.

Initially, an exemplary environment (e.g., a SyncML architecture) is described in which various aspects of the present invention may be carried out. In particular, FIG. 2 illustrates an overview of an exemplary architecture in which certain aspects of the present invention may be carried out. The overview illustrated in FIG. 2 is illustrative only of one possible environment and is no way intended to be limiting with respect to the aspects of the present invention (for example, the features of the present invention are not limited to a SyncML architecture).

Broadly speaking, a client device 10 communicates with a Sync server 30, which is in turn in communication with a service provider network 40 (however, in some examples, Sync handler 30 and service provider network 40 may be local with respect to each other). During a provisioning process of client device 10, Sync server 30 causes or initiates the creation of an account with service provider 40 based on an identifier associated with device 10. For example, client device 10 may displays an icon for backing up data to the user. Sync server 30, in response to selection of the icon, causes the creation of an account with service provider network 40, which allows for the back up (and synchronization) of user data from client device 10. In one particular example, Sync server 30 receives the identity of device 10 and causes the creation of the account with service provider network 40.

The account created with service provider network 40 is associated with the user device based on one or more of a unique identifier of the device (e.g., Media Access Control address (MAC address), International Mobile Equipment Identity (IMEI), Mobile Station Integrated Services Digital Network (MSISDN), or similar identifier), a portion of the user data, combinations thereof, or other such information that may be provided by the device (e.g., device generated) without additional input by the user when provisioning the device or creating the new account. Service provider network 40 and/or Sync handler 30 may thereafter provide device 10 a key in the form of new data for accessing the newly created account from device 10 and/or completing the registration (e.g., inputting conventional credentials) for the newly created account.

Sync server 30, in this example, is illustrated including a Sync handler 20 (shown as a “SyncML DataSync Handler”), a Backend Sync Handler 31, a local database or inventory 32, and a digest 50, all of which are operable to perform various back up and synchronization processes. Various components of Sync server 30 may include servers, databases, and other well known components. It is noted that the examples described here are shown and described generally for SyncML protocol (based generally on XML-schema) for illustrative purposes only; various other protocols and system architectures are possible and contemplated. Various features relating to Sync server 30 are further described in related U.S. patent application Ser. No. 11/273,891, filed Nov. 14, 2005, and entitled DATA SYNCRHONIZATION AND DEVICE HANDLING, to L. Yang, et al., the entire content of which is hereby incorporated by reference in its entirety as if fully set forth herein.

Client device 10 may communicate with Sync server 30 via a wireless network, such as a wireless gateway, e.g., a cellular, satellite, or other wireless network. Additionally, client device 10 may communicate via a non-wireless network such as a cable or fiber optic network, or a combination of wireless and non-wireless systems.

Client device 10 may include various devices including, for example, mobile devices such as a PDA, mobile telephone, smart phone, pager, walkie talkie, radio frequency (RF) device, infrared (IR) device, Wi-Fi device, pocket personal computer, tablet personal computer, laptop computer, and integrated devices combining one or more of the preceding devices, as well as a desktop computer, or the like. Client device 10 may include a processor connected to an input device such as a keyboard, a network interface, a memory, and a display. The memory may include logic or software operable with client device 10 to perform some of the functions described herein. Client device 10 may be operable to include a suitable interface for a messaging facility, such as an email inbox, instant messaging (IM), short messaging service (SMS), multimedia messaging service (MMS), and the like. Device 10 may further be operable to display a web browser for accessing the Internet, including webmail environments such as a Yahoo!® mail account or Hotmail® account, for example.

In one example, client device 10 communicates with Sync server 30 via Sync handler 20 such that client device 10 and Sync server 30 may exchange data (e.g., through a synchronization session to exchange client and/or server modifications to data). Through this communication, client device 10 is capable of backing up data and synchronizing with synchronization data stored with Sync server 30. By way of example only, client device 10 and Sync server 30 may use the wireless application protocol (WAP) or other data communication protocol of client device 10 to communicate. One of ordinary skill in the art will recognize that the Wireless Application Protocol (WAP) is only one way in which a wireless device can access data on a network and that any such data transfer technology may be used to access and transfer electronic data.

Sync server 30 is further operable to communicate with at least one remote database or service provider network 40. Service provider network 40 includes, e.g., data associated with the local synchronization data on Sync server 30, data associated with client 10, and the like. In one example, the service provider network 40 includes a service provider for creating and maintaining a user account such as a Yahoo!® user account, MSN® user account, for example. Additionally, the service provider network 40 may include one or more Personal Information Management (PIM) applications, such as Contacts, Calendar and the like.

It should be noted that although the exemplary methods and systems described herein describe the use of separate servers and databases for performing the various functions, other embodiments could be implemented by storing the software or programming that operates some of the described functions on a single server or any combination of multiple servers as a matter of design choice so long as the functionality described herein is performed. Although not depicted in the figures, components, such as Sync server 30, generally include such art recognized components as are ordinarily found in server systems, including but not limited to processors, RAM, ROM, clocks, hardware drivers, associated storage, and the like.

Various other features and functions may be used in combination with the above described slow sync process. For example, various other features may be included in combination; additionally, some features may be modified or omitted. Those of ordinary skill in the art will recognize that this example is illustrative only of one example of performing back up processes and synchronization sessions as described herein.

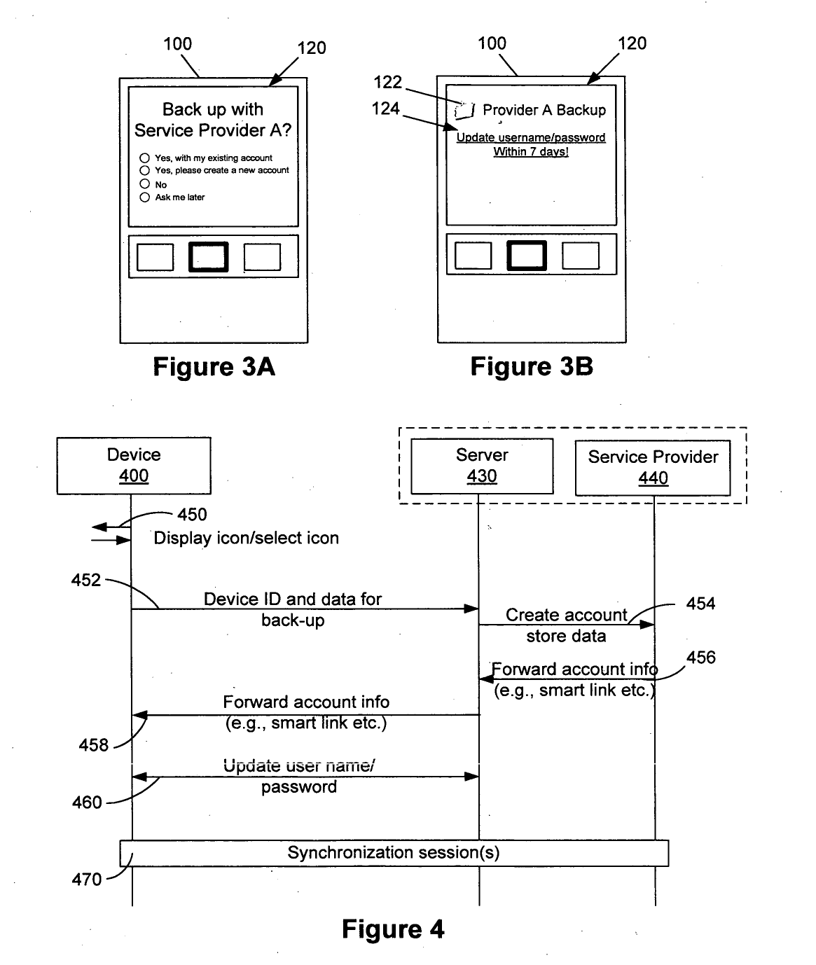

FIGS. 3A and 3B illustrate an exemplary user interface 120 of a client device 100 operable to prompt a user to back up data and access the data (which may further be synchronized). Additionally, FIG. 4 illustrates an exemplary signaling chart between a client device and a server device associated with a service provider network and which may be referenced in conjunction with the description of FIGS. 3A and 3B.

FIG. 3A illustrates an exemplary user interface 120 of a client device 100. When device 100 is initially used, e.g., during provisioning or initial set-up and configuration of device 100, a user may be prompted with a display such as “Back up with Service Provider A?” Display 120 may include various other messages for selecting a back up procedure, and any such message may be included as a menu item, window, pop-up screen, and so on.

Additionally, a user may be offered the option of selecting from one or more different service providers (e.g., providers A, B, C and so on) or different features or services of a single service provider (e.g., selecting between contacts, calendar information, etc.). The user may select from several options, for example, “yes, with my existing account,” “yes, please create a new account,” “no,” or “ask me later.” The user may further be prompted as to whether they want an automatically created account, e.g., without inputting a user name or password information, or would like to complete the registration or set-up of the account with a username and password. In other examples, device 100 may merely display “yes” or “no” and if “yes” is selected the device prompts the user whether they have an existing account with service provider A.

In yet other examples, the automatic account creation and back up operation may proceed as described without a user selection. For example, the automatic account creation may occur in response to the input of user data; after which, a link or indication to the user of the existence of the created account may be displayed. The user may then complete the registration for the new account or merge or synchronize the new account and data with an existing account (of service provider A or another).

In the instant example, after the user has selected to back up their data, display 120 displays an icon or folder 122 (or other indicium of the backup data) associated with device 100 and that has been backed up with the service created account (or when an existing account has been associated with device 100 and the user's data). A user may select folder 122 to access, back up, or synchronize the device data with their account. For example, device 100 may thereafter engage in SyncML sessions with a SyncML server as described above, the data accessibly via selection of folder 122.

Further, in one example, a smart link 124 may be created and communicated to device 100, the smart link 124 associated with the new account. Smart link 124 may be created and operable only from the particular device 100; for example, the smart link 124 may be based on the IMEI number, phone number of the device, or the like.

In one example, election of smart link 124 opens a browser window within display 120 and allows a user to perform a more complete registration process for the created account, e.g., entering or changing a username and password. When registered with a username and password the user may access their account online (e.g., from other devices) and edit their user data.

Smart link 124 displayed on device 100 may further include a reminder to update a username and password for their new account. In other examples, a reminder may be included in a separate display, as part of an SMS message, email message, entry into a calendar application, or the like.

An exemplary provisioning process is as follows for backing up a user's contacts with a contact application associated with the Yahoo!® service provider (of course, any service provider is contemplated), where the user does not have an existing Yahoo!® account.
1) User gets a new phone
2) User finds on the phone “back up your Contacts” icon
3) User presses on “back up your Contacts”.
4) A dialog appears “Do you want to back up with Yahoo!®?” <Yes> <No>
5) User selects <Yes>
6) Dialog appears “Do you have already a Yahoo!® Account?” <Yes> <No>
7) User selects <No>
8) Dialog appears “Yahoo! can create an automatic account. Do you want to process” <Yes> <No>
9) User selects <Yes>
10) Dialog appears “When synchronization is done please look for a new Yahoo! Backup contact” <Ok>
11) The device starts a synchronization session (e.g., a SyncML session) with Yahoo! server.
12) The device is uniquely identified by the IMEI.
13) Contacts from the device are uploaded to the Yahoo!® servers (e.g., new Yahoo!® accounts do not have contacts on the server).
14) A new contact name “Yahoo!® Backup” is generated and appears on the device.
15) The new contact contains a short description with a link (e.g., a smart link) and a unique identifier, e.g., an IMEI unless it's already in use. In such an instance, the unique identifier may include the IMEI and phone number of the device, for example.
16) User clicks on the link and is taken through a registration process. The user may convert the unique identifier (e.g., IMEI) with regular user name and passwords.
17) User now can log in to Yahoo!® to edit their contacts online.

In another example of the previously described provisioning process, after “9)” a user may be prompted with a dialog stating: “Please choose a recovery key” and “recovery key=- - - ”. A user may thereafter enter or select a recovery key for use in recovering or accessing the back up data in case of the loss of their user data or the device before they have completed the registration process, e.g., by entering credentials.

In another example, the exemplary method and system further provide a user the ability to back up their data on a new device, e.g., a mobile phone (e.g., if they lose a mobile phone, upgrade, etc, and get a new mobile phone). The new device may display an icon on the new phone for backing up information via service provider A. In this example, the user already has an account and therefore may enter their name and password to synchronize their account data (and effectively back up their user data from the previous phone) with the new phone. For example, once the correct credentials are entered a synchronization session may begin to back up appropriate user data to the new device.

Additionally, a key or token may be required to regain content if the phone is lost and the user registration (e.g., including credentials) was not completed. A key or token may be created from any information and given to the user for later access. In one example, the key is created from the user's personal information, e.g., their cell number plus personal information such their home phone number. Various manners to build up a key or token from personal information are possible and contemplated. Upon losing a device, the user may go to a recover site, e.g., a website, and enter the key or token to gain access to their backed up data.

FIG. 4 illustrates an exemplary signaling chart between a client device and a server device associated with a service provider network; in particular, the signaling between client device 400 and server 430 (which may include a SyncML server) and a service provider network 440. Server 430 and service provider 440 may be included with a single device, system, or service provider network (as indicated by the dotted lines) or may be located remotely to each other. For example, server 430 may include a SyncML server, which is in communication with a remote service provider network 440 backend.

In this example, device 400 may display an icon to the user at 450, and in response to user input, e.g., that the user wishes to back up user data, transmit or make available the device identifier and user data to server 430 at 452. In some examples, the device identifier and user data may be transmitted during a single synchronization session (e.g., a SyncML session); however, in other examples, the device identifier and user data may be transmitted in separate synchronization sessions. Additionally, the device identifier and/or the user data may be transmitted to server 430 prior to (or without) displaying an icon or a user selection to back up data.

Server 430 passes at least a portion of the information to service provider 440 at 454, and service provider 440 creates a new account based, at least in part, on the received device identifier. Information associated with the account, e.g., confirmation of successful back up, keys, a smart link address, notices, and the like may then be forwarded to device 400 via 456 and 458.

The user may create a username and password at 460, e.g., via a received smart link, which is communicated to server 430 and 440. Thereafter, device 400 may engage in conventional synchronization sessions 470 with server 430 and service provider 440 to synchronize and back up data with service provider 440.

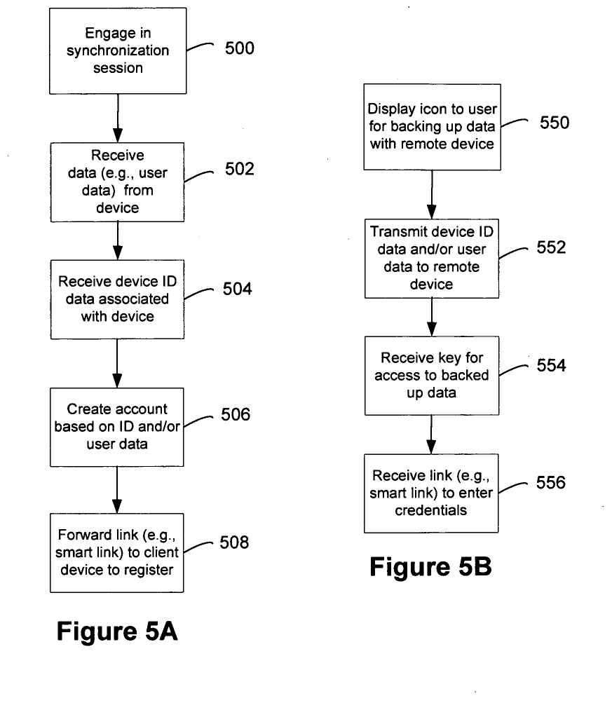

FIGS. 5A and 5B illustrate exemplary methods for backing up data and creating new accounts automatically, without user entered credentials. In particular, FIG. 5A illustrates an exemplary method for backing up data of a user device and FIG. 5B illustrates an exemplary method for backing up date to a remote device (e.g., a server associated with a service provider network).

In one example, the method for backing up data includes engaging in a synchronization session at 500. For example, a server (such as a SyncML server) may engage in a synchronization session with a device (such as a SyncML client). The server receives user data and a device identification or identifier (as described herein) during the synchronization session at 502 and 504. The user data and device identification may be received during a common synchronization session or during separate sessions (and the user data and device identification may further be received in any order).

The server may then cause the creation of an account at 506, the account associated with the device identifier, at least a portion of the user data, or both. In one example, the server that receives the information further includes logic for creating the account, in other examples, the information is transferred to a service provider for the creation of the account.

A notice or link may then be transferred to the device at 508 for the user to access the database and data that has been backed up. Further, the same or separate notice or link may notify a user to complete or update registering the device and the created account. In one example, a smart link or address may be provided where the user may access their data and enter credentials (a username and password).

With reference to FIG. 5B, an exemplary method for backing up user data on a client device includes displaying an icon at 550 that is user selectable to cause or initiate a back up process. The icon may be displayed and selected as described herein during provisioning of a device, for example.

The device communicates a device identifier and/or user data to the remote device at 552. The device identifier and/or user data may be transmitted in response to user input, e.g., a selection to back up the user data as well as an indication to back up the user data and create a user account. In some examples some or all of the data may already be available to the remote devices, e.g., in a SyncML environment a synchronization session may already have occurred or been initiated such that the server already received the device identifier and/or user data. In such an instance, the device may merely transmit the indication to back up the user data and create a user account.

The device may receive a key at 554 for accessing the data with the remote device. The device may additionally or alternatively receive a link to access the account and enter a username or password as previously described.

While aspects of the invention are described in terms of particular embodiments and illustrative figures, those of ordinary skill in the art will recognize that the invention is not limited to the embodiments or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic, and/or an appropriate combination thereof, as would be recognized by one skilled in the art to carry out the recited functions.) Software and firmware can be stored on computer-readable media. Some other processes can be implemented using analog circuitry, as is well known to one of ordinary skill in the art. Additionally, memory or other storage, as well as communication components, may be employed in embodiments of the invention.

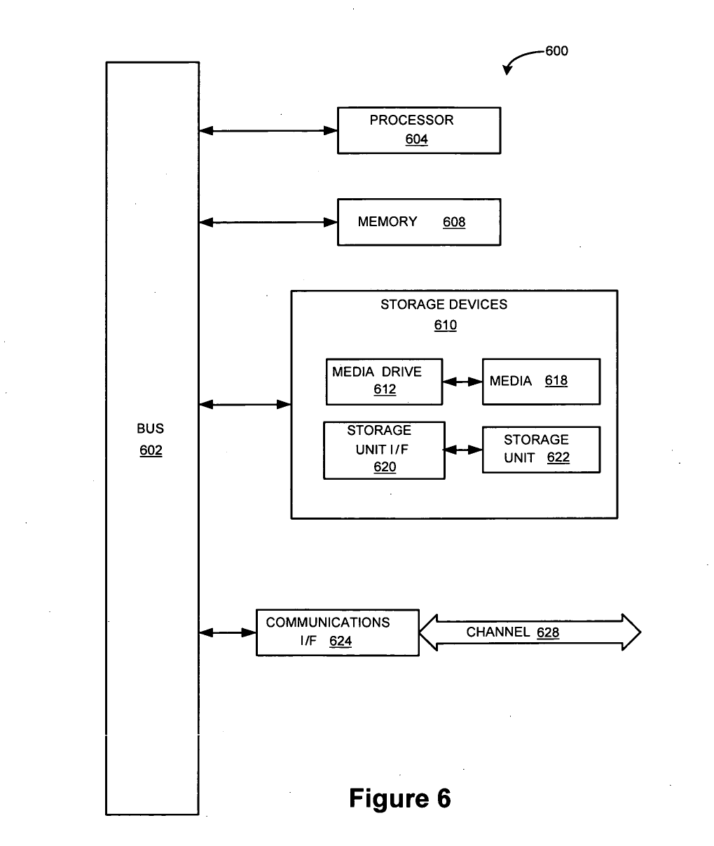

FIG. 6 illustrates an exemplary computing system 600 that may be employed to implement processing functionality for various aspects of the invention (e.g., as a client device or a server device described). Those skilled in the relevant art will also recognize how to implement the invention using other computer systems or architectures. Computing system 600 may represent, for example, a server (e.g., a SyncML server, a server associated with a service provider network, or the like), client device, desktop, laptop or notebook computer, hand-held computing device (PDA, cell phone, palmtop, etc.), mainframe, or any other type of special or general purpose computing device as may be desirable or appropriate for a given application or environment. Computing system 600 can include one or more processors, such as a processor 604. Processor 604 can be implemented using a general or special purpose processing engine such as, for example, a microprocessor, microcontroller or other control logic. In this example, processor 604 is connected to a bus 602 or other communication medium.

Computing system 600 can also include a main memory 608, preferably random access memory (RAM) or other dynamic memory, for storing information and instructions to be executed by processor 604. Main memory 608 also may be used for storing temporary variables or other intermediate information during execution of instructions to be executed by processor 604. Computing system 600 may likewise include a read only memory (“ROM”) or other static storage device coupled to bus 602 for storing static information and instructions for processor 604.

The computing system 600 may also include information storage mechanism 610, which may include, for example, a media drive 612 and a removable storage interface 620. The media drive 612 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 618 may include, for example, a hard disk, floppy disk, magnetic tape, optical disk, CD or DVD, or other fixed or removable medium that is read by and written to by media drive 614. As these examples illustrate, the storage media 618 may include a computer-readable storage medium having stored therein particular computer software or data.

In alternative embodiments, information storage mechanism 610 may include other similar instrumentalities for allowing computer programs or other instructions or data to be loaded into computing system 600. Such instrumentalities may include, for example, a removable storage unit 622 and an interface 620, such as a program cartridge and cartridge interface, a removable memory (for example, a flash memory or other removable memory module) and memory slot, and other removable storage units 622 and interfaces 620 that allow software and data to be transferred from the removable storage unit 618 to computing system 600.

Computing system 600 can also include a communications interface 624. Communications interface 624 can be used to allow software and data to be transferred between computing system 600 and external devices. Examples of communications interface 624 can include a modem, a network interface (such as an Ethernet or other NIC card), a communications port (such as for example, a USB port), a PCMCIA slot and card, etc. Software and data transferred via communications interface 624 are in the form of signals which can be electronic, electromagnetic, optical, or other signals capable of being received by communications interface 624. These signals are provided to communications interface 624 via a channel 628. This channel 628 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product” and “computer-readable medium” may be used generally to refer to media such as, for example, memory 608, storage device 618, storage unit 622, or signal(s) on channel 628. These and other forms of computer-readable media may be involved in providing one or more sequences of one or more instructions to processor 604 for execution. Such instructions, generally referred to as “computer program code” (which may be grouped in the form of computer programs or other groupings), when executed, enable or cause the computing system 600 to perform features or functions of embodiments of the present invention.

In an embodiment where the elements are implemented using software, the software may be stored in a computer-readable medium and loaded into computing system 600 using, for example, removable storage drive 614, drive 612 or communications interface 624. The control logic (in this example, software instructions or computer program code), when executed by the processor 604, causes the processor 604 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Although the present invention has been described in connection with some embodiments, it is not intended to be limited to the specific form set forth herein. Rather, the scope of the present invention is limited only by the claims. Additionally, although a feature may appear to be described in connection with a particular embodiment, one skilled in the art would recognize that various features of the described embodiments may be combined in accordance with the invention. Moreover, aspects of the invention describe in connection with an embodiment may stand alone as an invention.

Moreover, it will be appreciated that various modifications and alterations may be made by those skilled in the art without departing from the spirit and scope of the invention. The invention is not to be limited by the foregoing illustrative details, but is to be defined according to the claims.

What is claimed is:

1. An apparatus for creating an account associated with a client device, the apparatus comprising:
interface logic for receiving user data from a device;
identification logic for receiving identification information associated with the device; and
account logic for causing the creation of an account, wherein account credentials for the account are based on the identification information associated with the device.

2. The apparatus of claim 1, wherein the account is created without user entered account credentials.

3. The apparatus of claim 1, wherein the account credentials do not include user generated information.

4. The apparatus of claim 1, wherein the account is associated with a service provider.

5. The apparatus of claim 1, wherein the identification information comprises one or more of a Media Access Control address, International Mobile Equipment Identity, or Mobile Station Integrated Services Digital Network Identity.

6. The apparatus of claim 1, wherein the identification information is device generated.

7. The apparatus of claim 1, wherein the identification information is unique to the device.

8. The apparatus of claim 1, further comprising logic operable to initiate a request to the client device for a username and password.

9. The apparatus of claim 1, further comprising logic operable to communicate a smart link to the client device for updating the account.

10. The apparatus of claim 1, wherein the user data comprises data associated with a Personal Information Management application.

11. The apparatus of claim 1, wherein the user data comprises data associated with a Short Messaging Service or a Multimedia Messaging Service.

12. The apparatus of claim 1, wherein the user data comprises data associated with a media object.

13. A method for creating an account associated with a client device, the method comprising:
receiving user data from a device;
receiving identification information associated with the device; and
creating an account with a service provider for storing the user data, wherein the account credentials comprise the identification information of the device.

14. The method of claim 13, wherein the account credentials do not include user generated information.

15. The method of claim 13, wherein the identification information comprises one or more of a Media Access Control address, International Mobile Equipment Identity, or Mobile Station Integrated Services Digital Network identity.

16. The method of claim 13, wherein the identification information is unique to the device.

17. The method of claim 13, wherein the user data comprises data associated with a Personal Information Management application.

18. The method of claim 13, wherein the user data comprises data associated with a Short Messaging Service or a Multimedia Messaging Service.

19. The method of claim 13, wherein the user data comprises data associated with a media object.

20. A computer-readable medium encoded with computer program instructions for causing the creation of a user account associated with a remote device, the computer program instructions comprising:
program code operable to cause the creation of a user account with a service provider for backing up user data from a remote device, the account created based on identification information associated with the remote device.

21. The computer program product code of claim 20, wherein the account credentials do not include user generated information.

22. The computer program product code of claim 20, wherein the identification information comprises one or more of a Media Access Control address, International Mobile Equipment Identity, or Mobile Station Integrated Services Digital Network identity.

23. The computer program product code of claim 20, wherein the identification information is unique to the device.

24. The computer program product code of claim 20, wherein the user data comprises data associated with a Personal Information Management application.

25. The computer program product code of claim 20, wherein the user data comprises data associated with a Short Messaging Service or a Multimedia Messaging Service.

26. The computer program product code of claim 20, wherein the user data comprises data associated with a media object.
